(19) United States
(12) Patent Application Publication
(10) Pub. No.: US 2014/0365367 A1
(43) Pub. Date: Dec. 11, 2014

(54) Peer-To-Peer Network For Master Purchase Agreements

(71) Applicant: Uwe Schulz, Walldorf (DE)

(72) Inventor: Uwe Schulz, Walldorf (DE)

(73) Assignee: SAP AG

(21) Appl. No.: 13/914,122

(22) Filed: Jun. 10, 2013

(51) Int. Cl. G06Q 20/40; G06Q 50/18

(52) U.S. Cl. CPC G06Q 20/40; G06Q 50/18
USPC 705/44

(57) ABSTRACT

A system, a method and a computer program product for peer-to-peer network for master purchase agreements are provided. A request sent by a user equipment associated with an entity to register with a network configured to enable sharing of a master agreement among a plurality of entities is received by a server. The server generates a notification representative of a master purchase agreement being available at the server for access by the plurality of entities and sends the generated notification to the plurality of entities registered with the network to notify that the master purchase agreement is available on the network. The server receives a message sent by the user equipment associated with the entity. The server then generates a response to the message request to enable the entity to perform viewing of the master purchase agreement or the authorization to make the purchase under the master purchase agreement.

### TECHNICAL FIELD

This disclosure relates generally to data processing and, in particular, to a network for exchanging and obtaining documents, and in particular, various types of agreements.

### BACKGROUND

Private and/or public companies, governments, individuals frequently enter into various agreements to form a beneficial relationship. The relationship can include supplier-purchaser relationship, service provider relationship, and/or any other relationship. Some agreements can include varying terms and conditions, while some agreements can be so-called “master purchase agreements,” which are also referred to as blanket purchase agreements. These agreements can be used to bundle the purchasing power of entities within a single organization or, even, across organizations. Moreover, the master/blank agreement may be used to simplify the sourcing process by allowing a purchase to be made under an existing master/blanket agreement, rather than negotiating a new contract for each purchase. The master/blank agreement is common in large organizations, such as the government.

### SUMMARY

In some implementations, the current subject matter relates to a computer implemented method for providing a peer-to-peer network for master purchase agreements. The method can include receiving, by a server, a request sent by a user equipment associated with an entity to register with a network configured to enable sharing of at least one master agreement among a plurality of entities, where the master agreement can be representative of an agreement allowing the plurality of entities to use the master agreement for purchasing. The method can also include generating, by the server, a notification representative of a master purchase agreement being available at the server for access by the plurality of entities. The master purchase agreement can be provided by at least one of the plurality of entities registered with the network. The method can further include sending, by the server, the generated notification to the plurality of entities registered with the network to notify that the master purchase agreement is available on the network and receiving a message sent by the user equipment associated with the entity. The message can request at least one of a view of the master purchase agreement or an authorization to make a purchase under the master purchase agreement. The method can also include generating, by the server, a response to the message request to enable the entity to perform at least one of the view of the master purchase agreement or the authorization to make the purchase under the master purchase agreement.

In some implementations, the current subject matter can include one or more of the following optional features. The receiving can include receiving, by the server, information defining a type of master purchase agreements triggering generation of the notification and forwarding of the notification to the entity.

In some implementations, the method can include generating, by the server, at least one notification to the entity indicating a number of times that the master purchase agreement has been viewed by at least one entity in the plurality of entities. The plurality of entities can include at least one of the following: a governmental entity, a public entity, a private entity, a business entity, an organizational entity, and an individual entity.

In some implementations, the sending can include sending, by the server, the generated notification to the entity based on at least one notification preference of the entity, stored by the server, relating to a type of master purchase agreements being stored in the database.

Articles are also described that comprise a tangibly embodied machine-readable medium embodying instructions that, when performed, cause one or more machines (e.g., computers, etc.) to result in operations described herein. Similarly, computer systems are also described that can include a processor and a memory coupled to the processor. The memory can include one or more programs that cause the processor to perform one or more of the operations described herein.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 illustrates an exemplary network for sharing and/or using agreements, according to some implementations of the current subject matter;

FIG. 2 illustrates an exemplary system, according to some implementations of the current subject matter; and

FIG. 3 illustrates an exemplary method, according to some implementations of the current subject matter; and

FIG. 4 illustrates an exemplary network 400 for sharing master purchase agreements, according to some implementations of the current subject matter.

### DETAILED DESCRIPTION

A master purchase agreement, also referred to as a blanket purchase agreement, provides a contract vehicle for multiple purchases to be made, without requiring a re-negotiation of the terms and conditions of the agreement. Although these agreements can be useful, it is often difficult in a large organization, where a master purchase agreement is most likely to be used, for a user to be aware of the existence of the master purchase agreement. Indeed, a large organization, such as a large company or a government entity, may have dozens if not thousands of master purchase agreements in place, which makes it even more difficult for a user to be aware of the existence of the master purchase agreement and thus take advantage of that contract mechanism. The subject matter disclosed herein provides a network, such as a peer-to-peer network, to facilitate the awareness of agreements and other documents, such as master purchase agreements.

Governments as well as public and private entities enter and use various agreements to conduct business with one another. For example, a master purchase agreement may define the terms and conditions under which a plurality of purchases can be made over a certain period of time. To illustrate further, the government of Germany may enter into a master purchase agreement with a software vendor, and the master purchase agreement may allow agencies within the Germany government to make purchases of software from the software vendor, rather than require each agency to negotiate a master purchase agreement each time a purchase is required. In some instances, large organizations, such as the government, may have very complex contracting and sourcing requirements, so the use of master purchase agreements reduces the burden involved with purchasing. Although master purchase agreements are useful in many respects, these agreements can be overlooked because potential users may be unaware of the existence and/or terms and conditions of the master purchase agreements.

In some implementations of the current subject matter, there is provided a system that may include providing a collection of master agreements, such as master purchase agreements, blanket purchase agreements, and/or any other agreements that various entities can use, re-use and/or share between one another, where the agreements can contain various standard terms and conditions that can be used by the entities to enter into beneficial business relationships with other entities offering agreements with such standard terms and conditions. As used herein, a master agreement refers an agreement which can be used by various entities over a certain period of time. The master agreement can be executed (i.e., signed), a proposed agreement, and/or a template of an agreement.

The current subject matter may also provide ways to track usage of such agreements by the entities. Also, in some implementations, entities that use the agreements may also form a network of entities for the purposes of sharing the agreements. The current subject matter may also require entities willing to use agreements of other entities to submit an agreement having their own standard terms and conditions prior to using existing agreements. The current subject matter may also alert entities in the network when a new agreement (either from an existing network member-entity or a new entity) becomes available.

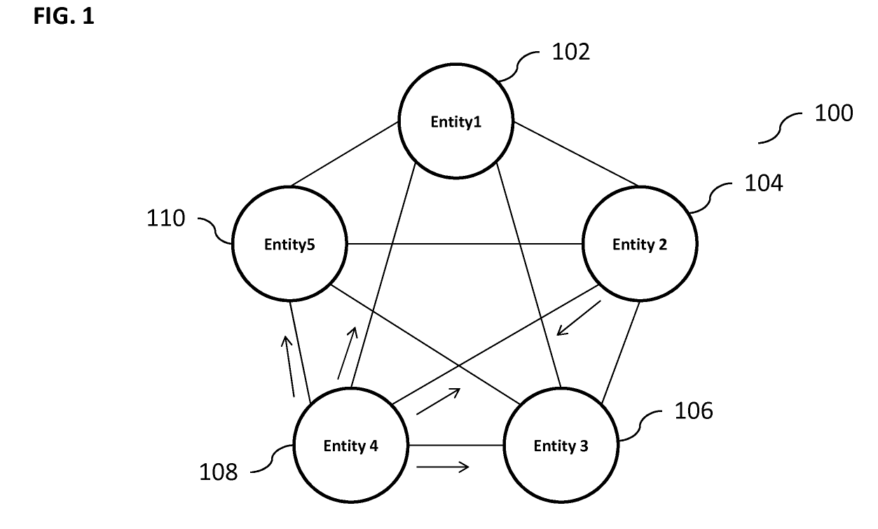

FIG. 1 illustrates an exemplary network 100 of entities for sharing various agreements, according to some implementations of the current subject matter. The network 100 can include participating entities 102, 104, 106, 108, and 110. The network 100 can include more than five entities shown in FIG. 1. Moreover, the interconnections among the participating entities 102, 104, 106, 108, and 110 are only an example, as other networking schemes may be used as well.

Any entity can also join the network 100 in order to access and/or use the agreements offered by the entities 102-110. The entities can be connected to one another via any computer network (as indicated by the lines connecting circles). The entities 102-110 can be governments, public entities, private entities, businesses, organizations, individuals, and/or any other entities. The entities 102-110 can be operating in any field of business (e.g., business applications, software, defense contracting, food products, machinery, etc.). The entities 102-110 can include purchasing systems and/or departments that can handle various purchasing or sourcing requests that may be received by the entities 102-110 from other entities in the network 100 and/or from third parties that are not members of the network 100. The entities 102-110 can also include users or purchasing officers that can oversee purchasing by the entities 102-110. Alternatively, the purchasing by entities 102-110 can be done automatically (e.g., when appropriate conditions for purchasing are met).

The member-entities 102-110 in the network 100 can make available to other entities in the network 100 their master purchase agreements, and/or any other agreements that can be used by entities 102-110 to enter into business relationships with entities offering such agreements. To use the agreement issued by a particular entity, e.g., entity 102, the other entities in the network 100, e.g., 104-110, can accept the terms and conditions of the issued agreement if the terms and conditions of that agreement fit the needs of such entities and are acceptable to them. Otherwise, the entities do not have to agree to particular terms and conditions, in which case no business relationship is consummated.

In some implementations, if an entity, e.g., an entity 108, issues a new agreement and makes it available for use by others in the network 100, the network 100 can issue a notification, such as a message, a text message, a social networking communication, and the like, that a new agreement has been made available by the entity 108 and if other entities wish to use, they may do so upon acceptance of its terms and conditions. The notification of the new agreement issued by entity 108 can be sent to all entities in the network 100, as indicated by the arrows next to entity 108. In some implementations, the notification can be sent to specific entities in the network, while other entities are excluded from a notification. Further, the entities in the network 100 can also set preferences, filters, key word searches, and the like regarding how (as well as with what) they would like to be notified of new agreements that are made available in the network 100. For example, a food products consumer entity can request that it only be notified if a food packaging contract is issued, and can request that it should not be notified if any other contract is issued.

In some implementations, the network 100 can also store agreement usage information as related to a particular agreement. Such usage information can be stored in a memory location and can be stored in association with a particular contract. The contracts and usages (and/or any other information) can be stored in a database (not shown in FIG. 1). The database can be accessed by the network 100 upon receiving an indication from entity that it wishes to do at least one of the following: submit an agreement for usage by others, use an existing agreement, submit usage information, modify an existing agreement, and/or perform any other functions.

In some implementations, the terms and conditions of some agreements in the network 100 can be government by various standards organizations. The organizations can be related to various products that are being offered by the entities for purchase through their agreements. Terms and conditions in the agreements can also be governed by international treaties and/or organizations, such as the World Trade Organization and the like.

In some implementations, each entity 102-110 in the network 100 can also include various contracting/purchasing software systems that can maintain contracts with entities' suppliers and can be used for sourcing of particular purchases of products and/or services that may be needed by the entities. The network 100 can also integrate such contracting/purchasing software systems of the entities 102-110, so that the entities are able to make their agreements available to others in the network 100. The entities 102-110 can also include various contracting officers that can release agreements for use by other entities in the network 100, receive notification of new agreements, as well as receive information on usages of the agreements (whether their own agreements or agreements by others).

In some implementations, new entities that desire to join the network 100 may be required by the network 100 to make available an agreement of their own for use by existing members either prior to joining the network 100 and/or prior to using one of the existing agreements. This can ensure that entities can advantageously share agreements with one another and benefit from business relationships that may be available to everyone in the network 100, as opposed to few selected network members.

In some implementations, the entities 102-110 can be automatically notified when a new agreement is made available by a member entity for use by everyone in the network. Alternatively, entities can determine their notification preferences based on products, services, prices, etc. that are being offered by member entities in the network 100. For example, a car manufacturer might not be interested in farming products and hence, can set a notification preference that may exclude agreements related to such products. The entities can be notified by any available means, which can include at least one of the following: email, regular mail, facsimile, telephone, etc. The notifications can include information about an agreement (e.g., entity offering the agreement, duration of the agreement, products/services, prices, a period during which the offer in the agreement is valid, terms and conditions, etc.), a copy of the agreement, usage information of the agreement, etc.

In some implementations, the current subject matter can provide entities with a common/central network that can be used by all participating (or member) entities to use agreements of other member-entities and/or offer agreements to everyone in the network. This can reduce sourcing efforts of the entities (e.g., competitive bidding, negotiation, closing, etc.) through use of agreements that might not have been previously known to them. The entities can also use their existing contracting systems and/or procedure in connection with the network 100. Further, other systems (e.g., bookkeeping, accounting, etc.) of the entities can also be integrated in the network 100.

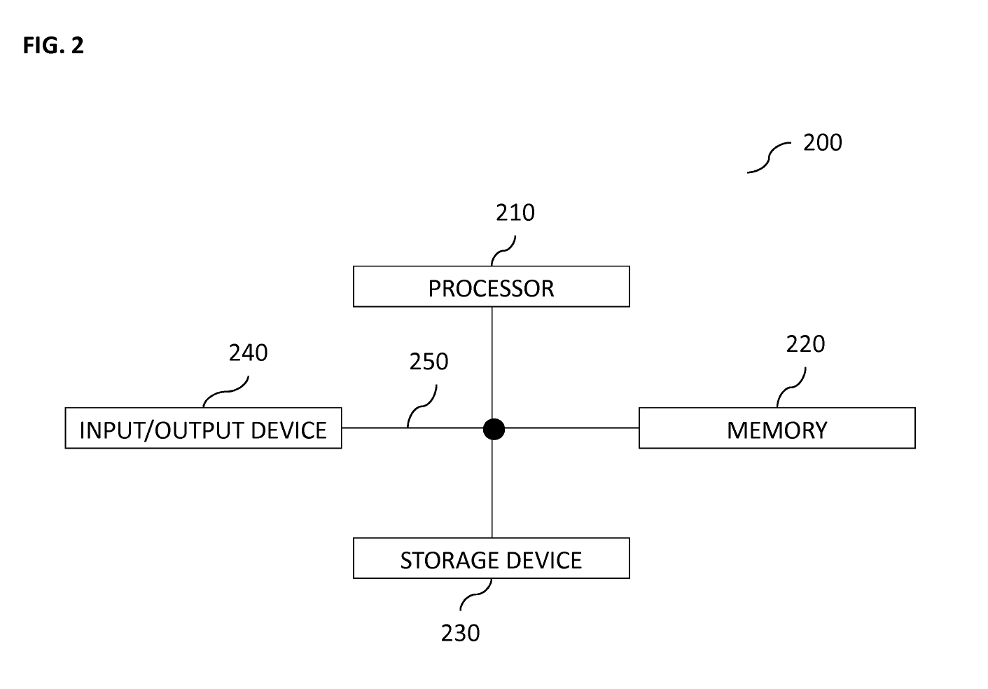

In some implementations, the current subject matter can be configured to be implemented in a system 200, as shown in FIG. 2. For example, each of the entities (labeled parties) at FIG. 1 may include system 200, although system 200 may be distributed so that the resources of system 200 can be shared by one or more entities. The system 200 can include a processor 210, a memory 220, a storage device 230, and an input/output device 240. Each of the components 210, 220, 230 and 240 can be interconnected using a system bus 250. The processor 210 can be configured to process instructions for execution within the system 200. The processor 210 can be further configured to process instructions stored in the memory 220 or on the storage device 230, including receiving or sending information through the input/output device 240. The memory 220 can store information within the system 200. In some implementations, the memory 220 can be a computer-readable medium. In alternate implementations, the memory 220 can be a volatile memory unit. In yet some implementations, the memory 220 can be a non-volatile memory unit. The storage device 230 can be capable of providing mass storage for the system 200. In some implementations, the storage device 230 can be a computer-readable medium. In alternate implementations, the storage device 230 can be a floppy disk device, a hard disk device, an optical disk device, a tape device, non-volatile solid-state memory, or any other type of storage device. The input/output device 240 can be configured to provide input/output operations for the system 200. In some implementations, the input/output device 240 can include a keyboard and/or pointing device. In alternate implementations, the input/output device 240 can include a display unit for displaying graphical user interfaces.

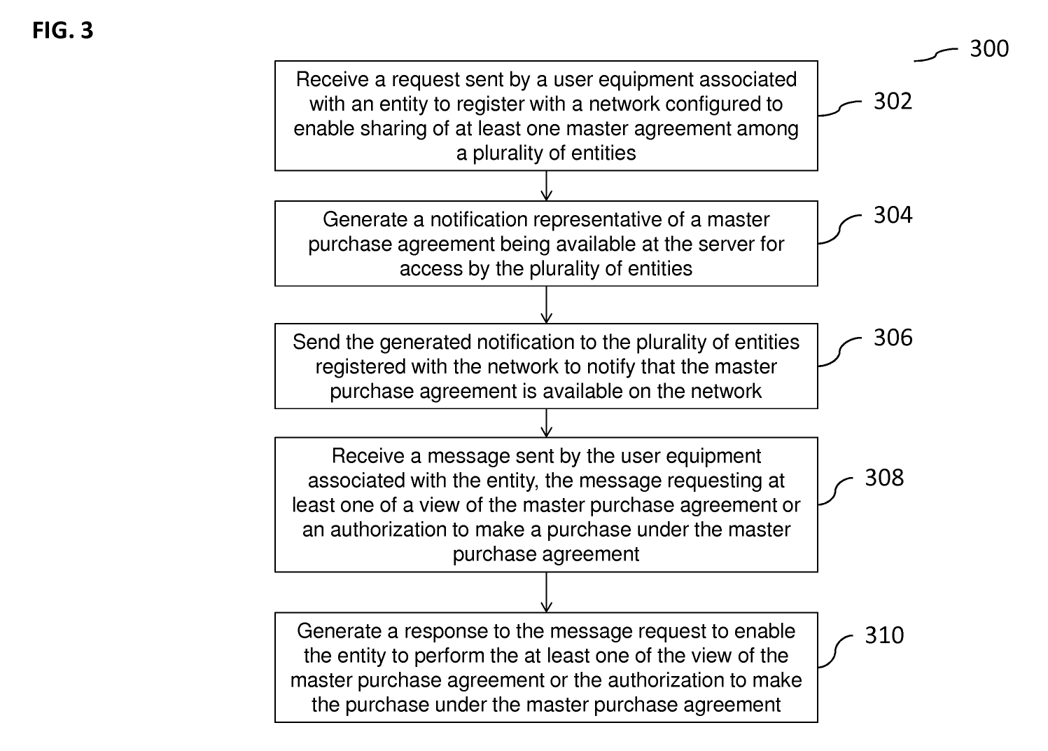

FIG. 3 illustrates an exemplary method 300, according to some implementations of the current subject matter. The network can be used for sharing a plurality of master agreements, such as master purchase agreements by a plurality of entities. For example, the network may comprise a network framework, such as a social network and the like, to which an entity registers to share agreements. The method 300 can be performed in the network that can include a server coupled to a repository, such as a database. Each entity can include a user equipment (e.g., a personal computer, a laptop computer, a mobile telephone, a smartphone, a tablet computer, etc.) for communicating with the server. The communication can be via a wireless and/or wired medium. The database can store the plurality of master purchase agreements. The method 300 can be used by entities 102-110 in the network 100 to make agreements available for use to one another.

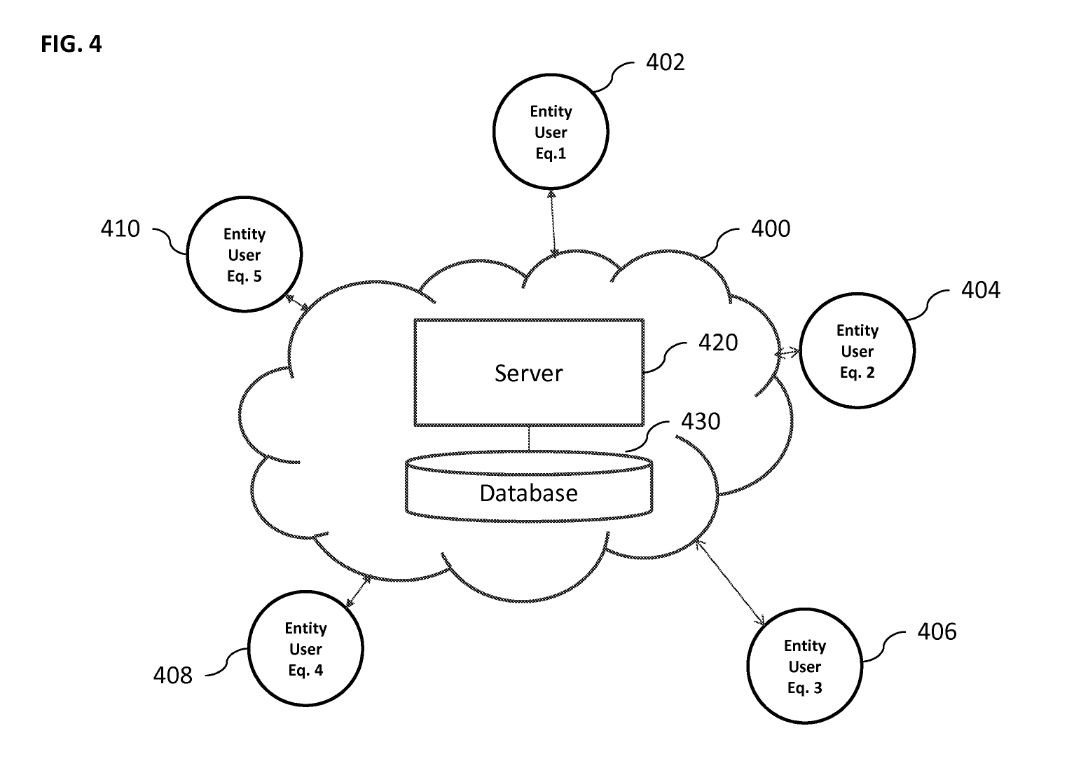

FIG. 4 illustrates an exemplary network 400 for sharing master purchase agreements, according to some implementations of the current subject matter. The network 400 can include a server 420 coupled to a database 430. The server 420 can store master purchase agreements in the database 430. The agreements can be submitted by the entities 102-110 (shown in FIG. 1) using user equipment 402-410, respectively, communicatively coupled to the network 400. User equipment 402-410 can be a personal computer, a laptop computer, a mobile telephone, a smartphone, a tablet computer, etc. The entities' purchasing systems can be integrated with the network 400 for handling of purchasing and/or sourcing requests that may be received by the entities 102-110, as discussed below.

Referring back to FIG. 3, at 302, a server can receive a request sent by a user equipment associated with an entity to register with a network configured to enable sharing of at least one master agreement among a plurality of entities. The master agreement can be an agreement allowing the plurality of entities to use the master agreement for purchasing. The entity can be in a network 100 that can include a plurality of entities, as shown in FIG. 1. The master purchase agreement can include terms and conditions offered by the entity as a condition for consummating a business relationship with the entity based on the agreement. In some implementations, a contracting system of the first entity (e.g., public entity, private entity, government entity, an individual, and/or any other entity) may generate the agreements.

At 304, the server can generate a notification representative of a master purchase agreement being available at the server for access by the plurality of entities. The master purchase agreement can be provided by at least one of the plurality of entities registered with the network. For example, a contracting officer (and/or any other employee) of the entity can release the agreement for viewing/usage by other entities in the network. This can be accomplished through storing the agreement in a database associated with the network, and/or sending a notification to entities in the network that a particular agreement is available for use. In some implementations, the entities form peers on a social network, so the notification is disseminated as a message sent to all of the peers registered on the social network to receive the notifications. In some implementations, an entity may register with network 100 and set filters defining what types of agreements should trigger a notification (e.g., master purchase agreements, information technology purchasing, and the like), when the notifications should be sent (e.g., time of day), email or phone numbers to which the notifications should be sent. In some implementations, the current subject matter can be integrated with entities' purchasing systems and is capable of retrieving master purchase agreements from the network, if such agreements fit various purchasing requests, requirements and/or needs of the entities and are available on the network for sharing. The purchasing system of the entity can handle various purchasing aspects of the entity's business. For example, a purchasing officer at an entity can receive a notification that a request was received by the entity's purchasing system for purchasing of particular goods and/or services. Based on the received request, the purchasing officer can communicate with the network that contains master purchase agreements to determine whether a suitable master purchase agreement exists that can accommodate the received request. Alternatively, the network can be contacted automatically upon receiving a request without involvement of the purchasing officer.

At 306, the server can send the generated notification to the plurality of entities registered with the network to notify that the master purchase agreement is available on the network. The notification can be sent via an email, an instant message, a short message service (“SMS”) message, a multimedia message service (“MMS”), and/or any other technique.

At 308, the server can receive a message sent by the user equipment associated with the entity. The message can include a request to view the master purchase agreement or an authorization to make a purchase under the master purchase agreement. For example, entity 106 can request to view the terms of the agreement offered by the entity 108, as shown in FIG. 1, and then use that contact vehicle during purchasing. The entity 106 can send a notification (e.g., an email, a letter of agreement, etc.) to the entity 108 requesting authorization to make a purchase under the terms and conditions in the agreement. In some implementations, a contracting officer of the entity (and/or any other employee) can be notified about agreements (new and/or existing ones) that can fit entity's various product categories. If agreement's terms and conditions are accepted by the officer, the agreement information can be included into the entity's contracting system and the agreement can be used for its intended purposes (e.g., purchasing of software products, business services, etc.). For example, referring to FIG. 1, entity 106 can include a purchasing system that can receive various sourcing requests for purchasing. The requests can be analyzed to determine whether there already exists a master purchase agreement in the network 400 (shown in FIG. 4) that may accommodate the requests, where the agreement can be provided by the entity 108 for sharing by the entities 102-110. If there is determination that an existing master purchase agreement of the entity 108 matches the needs of the sourcing requests received by the entity 106, the purchasing system of the entity 106 can appropriately notify the purchasing officer of the entity 106. The officer can then request the usage of this agreement. In some implementations, the above determination can be made based on a comparison of requirements and/or conditions outlined in the sourcing requests and terms and conditions of master purchase agreements that already exist in the network 400 (shown in FIG. 4).

At 310, the server can generate a response to the message request to enable the entity to perform the at least one of the view of the master purchase agreement or the authorization to make the purchase under the master purchase agreement. The response can be sent via an email, an instant message, a short message service (“SMS”) message, a multimedia message service (“MMS”), and/or any other technique.

In some implementations, if the terms of the master purchase agreement are acceptable to the entity, the entities can further communicate with one another in order to consummate a business relationship between themselves based on the master purchase agreement. In some implementations, the purchasing system of an entity can include various contact data (e.g., names, address, telephone numbers, emails, etc.) of the entity that may have released the master purchase agreement for sharing in the network 400 (shown in FIG. 4). The contact data can be used to contact the entity that released the agreement into the network via mail, e-mail, telephone, etc.

In some implementations, the current subject matter can include one or more of the following optional features. The server can also receive information defining a type of master purchase agreements triggering generation of the notification and forwarding of the notification to the entity.

In some implementations, the server can generate at least one notification to the entity indicating a number of times that the master purchase agreement has been viewed by at least one entity in the plurality of entities. The plurality of entities can include at least one of the following: a governmental entity, a public entity, a private entity, a business entity, an organizational entity, and an individual entity.

In some implementations, the server can send the generated notification to the entity based on at least one notification preference of the entity, stored by the server, relating to a type of master purchase agreements being stored in the database.

The systems and methods disclosed herein can be embodied in various forms including, for example, a data processor, such as a computer that also includes a database, digital electronic circuitry, firmware, software, or in combinations of them. Moreover, the above-noted features and other aspects and principles of the present disclosed implementations can be implemented in various environments. Such environments and related applications can be specially constructed for performing the various processes and operations according to the disclosed implementations or they can include a general-purpose computer or computing platform selectively activated or reconfigured by code to provide the necessary functionality. The processes disclosed herein are not inherently related to any particular computer, network, architecture, environment, or other apparatus, and can be implemented by a suitable combination of hardware, software, and/or firmware. For example, various general-purpose machines can be used with programs written in accordance with teachings of the disclosed implementations, or it can be more convenient to construct a specialized apparatus or system to perform the required methods and techniques.

The systems and methods disclosed herein can be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

As used herein, the term “user” can refer to any entity including a person or a computer.

Although ordinal numbers such as first, second, and the like can, in some situations, relate to an order; as used in this document ordinal numbers do not necessarily imply an order. For example, ordinal numbers can be merely used to distinguish one item from another. For example, to distinguish a first event from a second event, but need not imply any chronological ordering or a fixed reference system (such that a first event in one paragraph of the description can be different from a first event in another paragraph of the description).

The foregoing description is intended to illustrate but not to limit the scope of the invention, which is defined by the scope of the appended claims. Other implementations are within the scope of the following claims.

These computer programs, which can also be referred to programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including, but not limited to, acoustic, speech, or tactile input.

The subject matter described herein can be implemented in a computing system that includes a back-end component, such as for example one or more data servers, or that includes a middleware component, such as for example one or more application servers, or that includes a front-end component, such as for example one or more client computers having a graphical user interface or a Web browser through which a user can interact with an implementation of the subject matter described herein, or any combination of such back-end, middleware, or front-end components. The components of the system can be interconnected by any form or medium of digital data communication, such as for example a communication network. Examples of communication networks include, but are not limited to, a local area network (“LAN”), a wide area network (“WAN”), and the Internet.

The computing system can include clients and servers. A client and server are generally, but not exclusively, remote from each other and typically interact through a communication network. The relationship of client and server arises by virtue of computer programs running on the respective computers and having a client-server relationship to each other.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations can be within the scope of the following claims.

What is claimed:

1. A method comprising:
receiving, by a server, a request sent by a user equipment associated with an entity to register with a network configured to enable sharing of at least one master agreement among a plurality of entities, the master agreement representative of an agreement allowing the plurality of entities to use the master agreement for purchasing;
generating, by the server, a notification representative of a master purchase agreement being available at the server for access by the plurality of entities, the master purchase agreement being provided by at least one of the plurality of entities registered with the network;
sending, by the server, the generated notification to the plurality of entities registered with the network to notify that the master purchase agreement is available on the network;
receiving, by the server, a message sent by the user equipment associated with the entity, the message requesting at least one of a view of the master purchase agreement or an authorization to make a purchase under the master purchase agreement; and
generating, by the server, a response to the message request to enable the entity to perform the at least one of the view of the master purchase agreement or the authorization to make the purchase under the master purchase agreement.

2. The method according to claim 1, wherein receiving further comprises:
receiving, by the server, information defining a type of master purchase agreements triggering generation of the notification and forwarding of the notification to the entity.

3. The method according to claim 1, further comprising
generating, by the server, at least one notification to the entity indicating a number of times that the master purchase agreement has been viewed by at least one entity in the plurality of entities.

4. The method according to claim 1, wherein the plurality of entities includes at least one of the following: a governmental entity, a public entity, a private entity, a business entity, an organizational entity, and an individual entity.

5. The method according to claim 1, wherein the sending further comprises
sending, by the server, the generated notification to the entity based on at least one notification preference of the entity, stored by the server, relating to a type of master purchase agreements being stored in the database.

6. A computer program product comprising a machine-readable medium storing instructions that, when executed by at least one programmable processor, cause the at least one programmable processor to perform operations comprising:
receiving, by a server, a request sent by a user equipment associated with an entity to register with a network configured to enable sharing of at least one master agreement among a plurality of entities, the master agreement representative of an agreement allowing the plurality of entities to use the master agreement for purchasing;
generating, by the server, a notification representative of a master purchase agreement being available at the server for access by the plurality of entities, the master purchase agreement being provided by at least one of the plurality of entities registered with the network;
sending, by the server, the generated notification to the plurality of entities registered with the network to notify that the master purchase agreement is available on the network;
receiving, by the server, a message sent by the user equipment associated with the entity, the message requesting at least one of a view of the master purchase agreement or an authorization to make a purchase under the master purchase agreement; and
generating, by the server, a response to the message request to enable the entity to perform the at least one of the view of the master purchase agreement or the authorization to make the purchase under the master purchase agreement.

7. The computer program product according to claim 6, wherein receiving further comprises:
receiving, by the server, information defining a type of master purchase agreements triggering generation of the notification and forwarding of the notification to the entity.

8. The computer program product according to claim 6, wherein the operations further comprise
generating, by the server, at least one notification to the entity indicating a number of times that the master purchase agreement has been viewed by at least one entity in the plurality of entities.

9. The computer program product according to claim 6, wherein the plurality of entities includes at least one of the following: a governmental entity, a public entity, a private entity, a business entity, an organizational entity, and an individual entity.

10. The computer program product according to claim 6, wherein the sending further comprises
sending, by the server, the generated notification to the entity based on at least one notification preference of the entity, stored by the server, relating to a type of master purchase agreements being stored in the database.

11. A system comprising:
at least one programmable processor; and
a machine-readable medium storing instructions that, when executed by the at least one programmable processor, cause the at least one programmable processor to perform operations comprising:
receiving, by a server, a request sent by a user equipment associated with an entity to register with a network configured to enable sharing of at least one master agreement among a plurality of entities, the master agreement representative of an agreement allowing the plurality of entities to use the master agreement for purchasing;
generating, by the server, a notification representative of a master purchase agreement being available at the server for access by the plurality of entities, the master purchase agreement being provided by at least one of the plurality of entities registered with the network;
sending, by the server, the generated notification to the plurality of entities registered with the network to notify that the master purchase agreement is available on the network;
receiving, by the server, a message sent by the user equipment associated with the entity, the message requesting at least one of a view of the master purchase agreement or an authorization to make a purchase under the master purchase agreement; and
generating, by the server, a response to the message request to enable the entity to perform the at least one of the view of the master purchase agreement or the authorization to make the purchase under the master purchase agreement.

12. The system according to claim 11, wherein receiving further comprises:
receiving, by the server, information defining a type of master purchase agreements triggering generation of the notification and forwarding of the notification to the entity.

13. The system according to claim 11, wherein the operations further comprise
generating, by the server, at least one notification to the entity indicating a number of times that the master purchase agreement has been viewed by at least one entity in the plurality of entities.

14. The system according to claim 11, wherein the plurality of entities includes at least one of the following: a governmental entity, a public entity, a private entity, a business entity, an organizational entity, and an individual entity.

15. The system according to claim 11, wherein the sending further comprises
sending, by the server, the generated notification to the entity based on at least one notification preference of the entity, stored by the server, relating to a type of master purchase agreements being stored in the database.
